(19) United States
(12) Patent Application Publication
(10) Pub. No.: US 2024/0294104 A1
(43) Pub. Date: Sep. 5, 2024

(54) MODULAR TRANSPORTER DEVICE

(71) Applicant: STRADOT, Pompertuzat (FR)

(72) Inventor: José IRIARTE, Pompertuzat (FR)

(21) Appl. No.: 18/260,671

(22) PCT Filed: Jan. 13, 2022
(86) PCT No.: PCT/FR2022/000001

§ 371 Date: Aug. 2, 2023

(30) Foreign Application Priority Data
Jan. 13, 2021 (FR) 2100291
Feb. 25, 2021 (FR) 2101817

(51) Int. Cl. B60P 1/64; B60P 3/42; B66C 19/00

(52) U.S. Cl. CPC B60P 1/6418; B60P 3/423; B66C 19/00

(57) ABSTRACT

The invention relates to a transporter device (3a) for moving and parking modules (2), each module (2) being devoid of its own traction means, the transporter device being moveable and comprising at least one module gripping means configured to be movable between a gripping position wherein the gripping means extends at least partially under or inside the module, preferably in the bottom sector or via the underneath of the module, and a release position wherein the gripping means does not extend into the module, said gripping means being configured to support the weight of the module (2), the device comprising at least one computer associated with sensors, for controlling the movement of the transporter device (3a) and the gripping means. The device comprises at least one column and at least one upright connected to said column, and is configured to be able to straddle the modules. The invention also relates to a robotic system and a corresponding program.

The invention relates to the field of means for terrestrial transportation of persons and goods. The invention relates more particularly to a transporter device that makes it possible to reduce the number of vehicle lanes necessary to move them, while increasing the productivity and comfort of these road transport operations.

In particular, but not exclusively, the present invention is intended for automatic, semi-automatic or manual transportation of persons and goods in urban environments.

In this field, transport vehicles conventionally move in different lanes depending on the direction of movement in order to avoid collisions or to allow more vehicle flow in a particular direction.

This conventional solution of vehicles in an urban environment is not fully satisfactory because it consumes land resources for creating multiple lanes of traffic. Furthermore, these vehicles are generally in a fixed configuration, thus limiting the possible applications for a given vehicle. For example, a vehicle dedicated to transporting people is typically not suitable for transporting goods and vice versa.

Furthermore, the stopping or parking of a vehicle on one of these lanes blocks traffic if other lanes are not present.

This need for multiple lanes to manage the simultaneous movement of vehicles, particularly when this movement is in opposite directions, entails a significant infrastructure cost. In addition, it entails a reduction in the space available for other urban uses, in particular dwellings and pedestrian spaces.

These disadvantages have in particular made difficult to redevelop cities.

Modular shuttle transporter devices according to the state of the art (“modular vans” or vehicles with a “skateboard-pod” architecture) have a flat chassis (the “skateboard”) and a plurality of interchangeable modules (the “pod” or module) having a certain advantage, however, these devices are not fully satisfactory. Indeed, these devices typically comprise a flat chassis associated with a traction system, and the interchangeable modules are installed on and removed from the chassis by means of an external handling device and/or human labor. Typically, the installation and removal operations are carried out from the top of the chassis or from one side of the chassis.

Unfortunately, the chassis and traction system of these vehicles being spread out near the ground does not allow effective sharing of traffic lanes, and more particularly do not allow other vehicles to pass or move in the opposite direction within the same lane.

Furthermore, the need for an external handling device and/or auxiliary assistance limits the possible exchange sites of the modules and/or limits how quickly the modules can be exchanged, and more particularly does not allow easy deposition or recovery of modules in the middle of the lanes or in unequipped sites.

In addition, the prior art devices can transport only one module at a time.

Other prior art solutions seeking to solve the above problems also have drawbacks that limit urban space optimization and the operation of a fleet of transporters intended for people and goods.

For example, the device described in patent document US2016272223 A1 does not allow the detachment and exchange of modules. Also, it does not explain how two simultaneously loaded transporters of operational modules can pass one another the same traffic lane.

Mention may also be made of patent documents US2019322204 A1 and US2018265293 A1. The device proposed in these documents constrains the design of the module because it requires a central upper adapter for gripping and lifting, which has a plurality of drawbacks:
a. Such an adapter is difficult to implement from a mechanical and functional point of view. For example, it is not suitable for transporting conventional maritime shipping containers or pallets.
b. The adapter is not compatible with the lifting of a plurality of modules, nor with the lifting of modules with different two levels (that is to say, simultaneous transport of one module atop another)
c. To go over other transporter or module devices on the road, the device described in these documents cannot be moved while being loaded with a module. Unless the height of its columns is considerably increased. And if it is, the additional height to go over will be too great and difficult to implement because of the large size variation of any telescopic columns.

Furthermore, this device has its wheels in an interlocked configuration of the pivoting gate type. This solution does not allow for passing over from the side and greatly limits the deflection radius.

The systems with centered gripping means, as described in patent document US2016272223, or by bending arm or crane structures, as described in the patent document WO2019133790 A1, further have other drawbacks, including in particular the problem of the module-gripping speed and the addition of significant constraints in the design of said modules.

The solution proposed in patent document WO2019133790 A1 thus proposes a “blocking” concept for the road. Another major drawback of this solution is that during the lifting of a module, the center of gravity of the transporter system with the transported module must be kept within the footprint of the traction wheels in order to avoid tilting the assembly. This feature limits the weight for the module at the time of lifting. This limitation constrains, for example, the anticipated loading of persons or goods on the module placed on the ground, and consequently leads to a loss of time and comfort for users. For the reason mentioned (dangerous movement of the center of mass), this concept is not suitable for lifting modules that already contain people inside.

Thus, a first objective of the invention is to propose a device that is less constraining and more flexible in order to further optimize the movements and the capacity of modules (the modules being without their own traction means) in traffic lanes shared by other devices, other modules or objects either in motion or stopped.

A second objective is to propose a better bidirectional transport system and to optimize the use of the space of traffic lanes relative to the prior art.

A third objective is to propose better means for gripping and managing interchangeable modules relative to the prior art.

To achieve these objectives, the invention proposes a transporter device for moving and parking modules (the modules being without its own traction means, as distinct from the notion of vehicles). The modules can be, for example, containers, pallets, or modular shuttles for transporting people, or similar. The transporter device is movable and comprises at least one module gripping means configured to be movable between a gripping position wherein said gripping means extends at least partially under or inside the module, preferably in the bottom sector or via the underneath of the module, and a release position in which said gripping means does not extend below or into the module, said gripping means being configured to support the weight of at least one module, the device comprising at least one computer associated with sensors, configured to control the movement of the transporter device as well as said gripping means. The transporter device further comprises at least one column, and at least one upright connected to said column, and the transporter device is configured to be able to straddle the modules.

Advantageously, this arrangement makes it possible to produce a robotic device controlled by the computer.

Said gripping means can be retractable (vertically and/or horizontally), and/or of variable length (telescopic or scissor type, for example).

Said gripping means can be integrated into a column, vertical guide, or into a longitudinal upright, the upright potentially being movable.

Said gripping means can vary its position along an upright and/or along a guide and/or along a column. Said longitudinal upright can have vertical mobility by a system of vertical guides or a lifting system connected to the column and/or to fixed uprights.

In particular, said gripping means is movable between a lower position wherein said gripping means comes into contact with the module when it is arranged on the ground, and an upper position wherein said upright is arranged above the height of the module. The gripping means can be placed at a plurality of intermediate levels.

In order to lift one or more modules, the transporter device comprises a lifting system that can be composed of lifting chains, winding of cables, jacks, telescopic (linear or pivoting) structures, ball screws and/or rack-and-pinions (8f), and may be associated with vertical guides or not.

Advantageously, the transporter device does not require a fixed upright in the lower position, which makes it possible to have space at the bottom and to be able to straddle modules or other devices on the longitudinal side and on the lateral side. The transporter device is easily manageable since it makes it possible to straddle modules and other devices placed on the ground or in motion on the traffic lane. Furthermore, the device does not require significant modifications to the lane to be functional.

The solution makes it possible to compose multiple routes of modules with a smaller number of routes of transporter devices, thus maximizing the rate of occupancy of the modules and the profitability of the transport systems (km-modules vs km-traction).

In one variant, the solution makes it possible to laterally straddle the modules in order to recover modules, for example on the sidewalk or in small street parking spaces.

For passenger mobility applications, people can wait inside the module the arrival of the transporter device. These passengers do not need to exit the module to allow the lifting of said module by the transporter device. This aspect improves user comfort and overall optimization of the time and resources of the transport and mobility network.

Another advantage provided by the innovation is that the module gripping means allows faster and more robust gripping of the module because the proposed concept is more tolerant to any misalignments of the transporter relative to the module on the ground (control error, sensor error, external disturbances, etc.) at the time the module is gripped by the transporter to be lifted (or carried).

The variable-size gripping means as proposed in our invention allow the transporter device to change its size (by actuation of telescopic devices and reorientation of the traction wheels) without the need to modify the geometry of the modules or to have to unload the module in order to change the size of the device; this aspect makes it possible, for example to change size without interrupting movement (saving time on trips). According to other aspects taken in isolation, or combined according to any technically feasible combination:
the upright is a longitudinal upright movably mounted between a lower position wherein said longitudinal upright makes it possible to position said gripping means at least partially below or inside the module when the latter is placed on the ground, and a higher position wherein said longitudinal upright is arranged above the height of the module;
the transporter device comprises a traction system associated with multidirectional or pivoting wheels, controlled by said computer; and/or
the columns and/or uprights are adjustable in size. This allows the transporter device to be configured to straddle, be straddled by, or move from underneath another, second transporter device, the two transporters being able, individually, to carry modules; and/or
the transporter device further comprises at least one upright, which can be fixed or moved; and/or
the device comprises at least one vertical guide for guiding the movements of the gripping means; and/or
the device comprises at least one vertical guide for guiding the movements of the movable upright; and/or
the vertical guide is equipped with at least one gripping means; and/or
said gripping means comprises independent articulated arms, and/or
said gripping means comprises telescopic arms, for example of the scissor type; and/or
said longitudinal upright is equipped with said gripping means; and/or
said gripping means can vary its position along the longitudinal uprights, guides and columns; and/or
said gripping means is configured to perform a module gripping by the chassis of the module, by the treads of auxiliary wheels or by an auxiliary carrying platform; and/or
the transporter device comprises at least one lifting system and the lifting system comprises lifting subsystems that are attached to and/or integrated with at least one upright; and/or
the transporter device comprises at least one lifting system and the lifting system comprises lifting subsystems that are attached to and/or integrated with at least one column; and/or
the transporter device comprises a lifting system and the lifting system comprises telescopic structures; and/or
the transporter device comprises a lifting system and the lifting system comprises lifting chains, jacks, cable winding, ball screw and/or pinion-and-rack, and is associated with movable upright guides preferably arranged in the columns; and/or
the transporter device comprises at least two independent lifting systems and each lifting system is associated with guides, said guides preferably being arranged in the columns and/or between the columns; and/or
the lifting system is integrated into the upright and the guides are integrated into the columns; and/or
the transporter device comprises a plurality of vertical guides and a plurality of columns, each column being provided with a plurality of vertical guides;
the transporter device comprises a plurality of columns, the or each vertical guide being arranged between the columns;
the transporter device is characterized by a central symmetry structure, in particular for one or more of said gripping means, said upright, said column, said traction system, and/or said lifting system; and/or
the transporter device is characterized by the carrying of at least one non-detachable module; and/or
said module gripping means is arranged substantially in the lateral sides of said transporter device; and/or
said module gripping means is configured to lift said module by a contact grip generally located below said module; and/or
said module gripping means is pivotable; and/or
the height of the transporter device is less than twice the height of the transportable modules; and/or
the lifting system comprises pivotable structures attached to at least one upright; and/or
the transporter device is configured to transport more than one module; and/or
the transporter device is configured to simultaneously grip and transport at least two modules in a multi-level configuration; and/or
the transporter device comprises at least one manipulation/inspection arm, preferably robotic; and/or
the transporter device further comprises at least one fixed upright carrying one or more of said movable uprights; and/or
said gripping means can vary its position along said longitudinal upright and/or along a guide and/or along a column; and/or
the computer being further configured to drive said longitudinal upright; and/or
the transporter device is configured to be able to straddle modules or other transporter devices laterally and/or longitudinally; and/or
at least one column and an upright of said transporter are of variable size.

The invention further relates to a system for moving and parking modules, comprising at least two transporter devices according to the invention, controlled in tandem or in a coordinated manner if the devices are in motion, or in a relative manner if at least one of the devices is stopped.

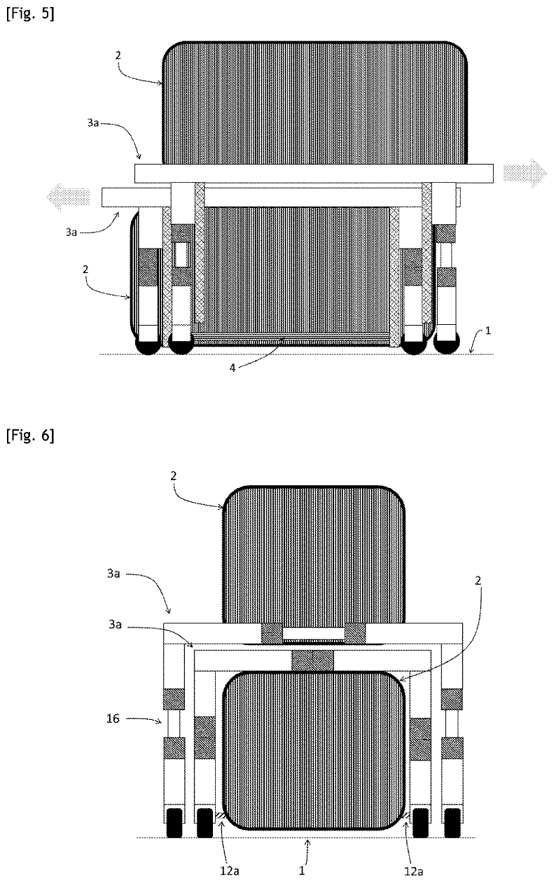

Another object of the invention relates to a method for transporter devices to move and to pass one another in opposite directions, comprising at least two transporter devices, wherein the system comprises a step of geometric adaptation (of the size of the transporter and/or of the vertical positioning of any modules being carried) by at least one of the devices and a second step of movement-by at least one of the devices-generally aligned and generally on the same trajectory between at least two transporter devices, as shown in FIGS. 5, 6, 7 and 12.

In particular, the method is carried out by means of a system for moving and holding according to the invention, for at least one device in motion along a lane, the movement of which is blocked by the presence of at least one other device, in motion or stopped on the same lane, or a module stopped on the same lane, creating a traffic jam on said lane and the method comprises steps for avoiding blocking traffic due to conflict with the device or module that is in the way.

Preferably, the method is implemented with the coordination of at least two transporter devices, to identify them as an enveloping (or exterior) device and an enveloped (or interior) device, and comprises steps of varying the geometry of one or both devices in order for the enveloping device to be wider and higher than the enveloped device, and that when carrying modules the same are positioned in an upper level (for enveloping devices) or in a lower level (for of enclosed devices). If a device is not carrying modules, it is sufficient to configure the gripping means to allow passing.

In particular, if the enveloping device carries at least one module, the method is implemented with the height positioning of said module(s) by the lifting system allowing the enclosing device to straddle the device being overtaken.

In particular, if the overtaken device carries at least one module, the method is implemented with the height positioning of said module(s) by the lifting system allowing the enclosing device to straddle the device being overtaken.

The invention further relates to a system for moving and holding modules, comprising at least two transporter devices according to the invention.

The invention further relates to a method for moving transporter devices, carried out by means of a movement and parking system as described above, the method comprising a step of positioning and aligning the transporter devices on a single lane, a step of geometric adaptation of the size of a first transporter device; and a step of straddling a second transporter device carried out by said first transporter device.

According to other aspects taken in isolation, or combined according to any technically feasible combination:
the method further comprises a module gripping step carried out by one of the transporter devices, and a step of moving the module carried out by at least one of the transporter devices; and/or
the method further comprises a module parking step carried out by at least one of the transporter devices; and/or
during the geometric adaptation step of the size of the transporter device, a plurality of geometric matching operations are carried out, before and/or after the movement of the module; and/or
the method further comprises a step, carried out by the transporter device, which has gripped the module, of vertically positioning the module on the transporter device.

The invention further relates to a computer program comprising program code instructions for the execution of the steps of a method according to the invention or the steps of implementing a transporter device according to the invention, when said program operates on a computer.

The invention will be further detailed by the description of non-limiting embodiments, and based on the attached figures showing variants of the invention, wherein:

FIG. 1 schematically shows a lateral (side) view of two devices according to a first preferred embodiment of the invention. The right image represents the device with the telescopic system of the columns extended to increase the height of the device. The gripping means are retracted inside the movable longitudinal upright.

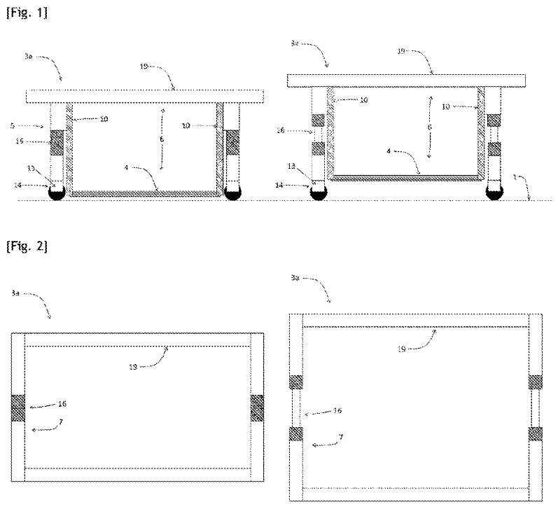

FIG. 2 schematically shows an upper (top) view of two devices according to the first embodiment. The right image represents the device with the transverse telescopic system extended to increase the width of the device.

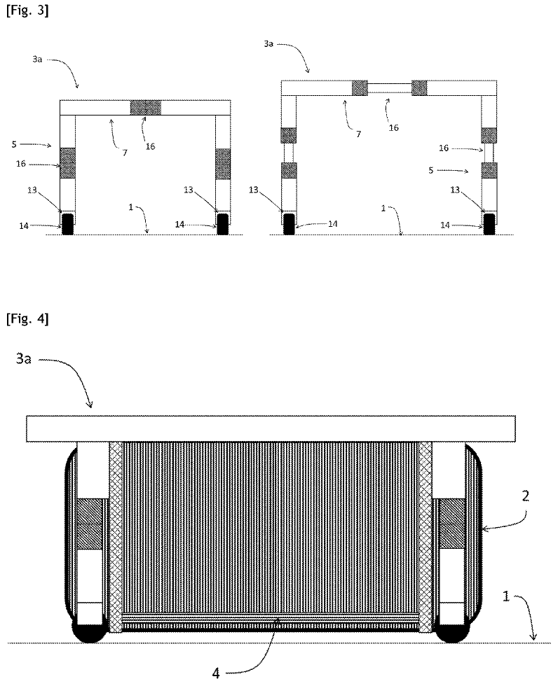

FIG. 3 schematically shows a front view of two devices according to the first embodiment. The right image represents the device with the telescopic systems extended to increase the overall size of the device.

FIG. 4 schematically shows a side view of a device carrying a module according to the first embodiment.

FIG. 5 schematically shows a side view of two devices moving in opposite directions (the meaning of the right and left arrows) sharing the same lane (or path), each transporter device carrying a module at a different height from the ground (or different levels).

FIG. 6 schematically shows a front view of two moving in opposite directions sharing the same lane (or trajectory), each bearing a module at a different height from the ground (or different levels). The module gripping means are visible for the case of the transporter device in the interior (or lower) position. The gripping means of the upper transporter device are hidden by the longitudinal upright facing it.

FIG. 7 schematically shows an upper (top) view of the situation presented in

FIG. 6. The module gripping means (scissor type in this embodiment) are visible for the two transporter devices. The gripping means of the upper transporter device are further extended to allow the widening of the transporter device.

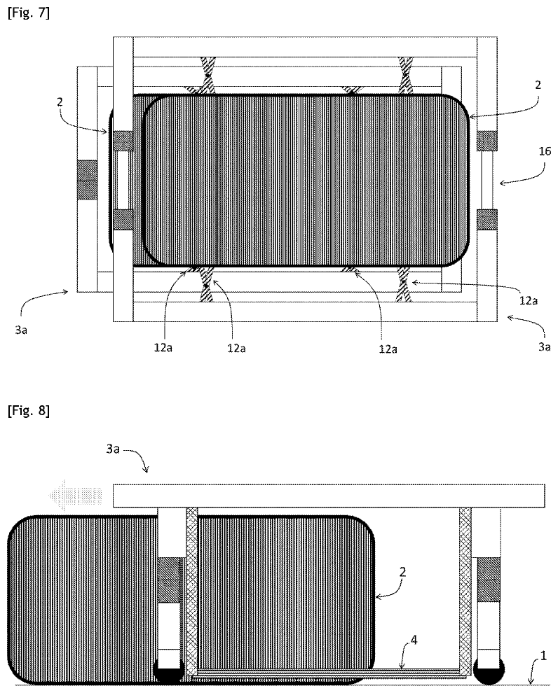

FIG. 8 schematically shows a side view (on the side) of a device by straddling a module placed on the ground (lane). The lateral movable upright is in a lower position, finally allowing the module gripping means to make contact with and lift said module.

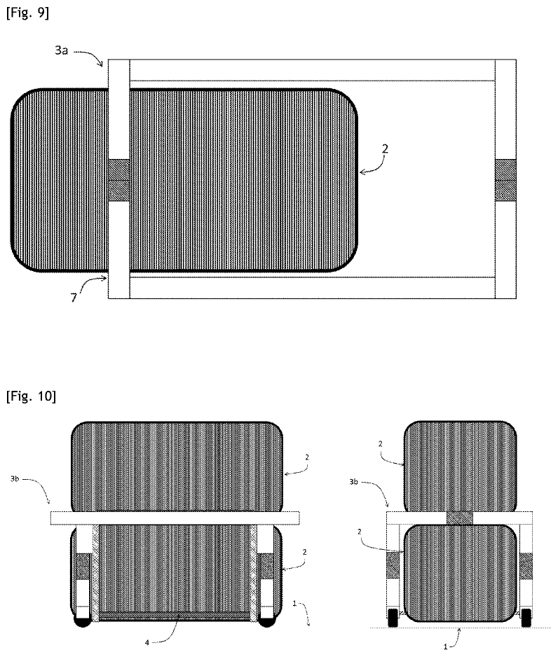

FIG. 9 schematically shows an upper view of the situation of FIG. 8.

FIG. 10 schematically shows a side view (on the left) and frontal view (on the right) of a device, according to a second embodiment, in the process of transporting two modules. This embodiment has two independent movable uprights on each lateral side of the device. Each movable upright having module means and specific vertical guides in order to allow the simultaneous lifting of two modules and at separate levels.

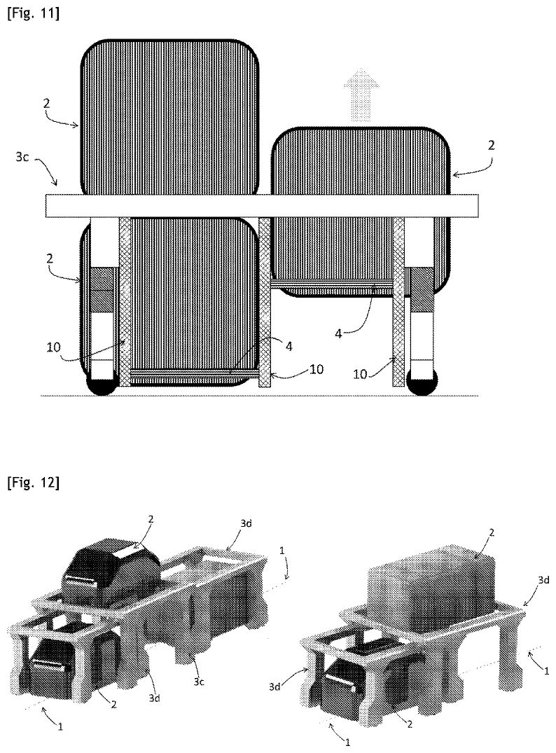

FIG. 11 schematically shows a side view of a device according to a third embodiment. This device is equipped with intermediate vertical guides and smaller movable uprights between these guides. The device shown is in the process of transporting three modules of smaller size. The furthest-right module is being raised to the top height (see upward arrow).

FIG. 12 shows 3D perspectives with transporter devices moving in opposite directions, generally on the same lane according to a fourth embodiment. The module gripping means (not visible in the images) are integrated directly into guides positioned in the columns (that is, no need for movable lateral uprights). The grooved parallelepipedal modules represent modules for transporting goods. More stylized blocks represent modules for transporting people.

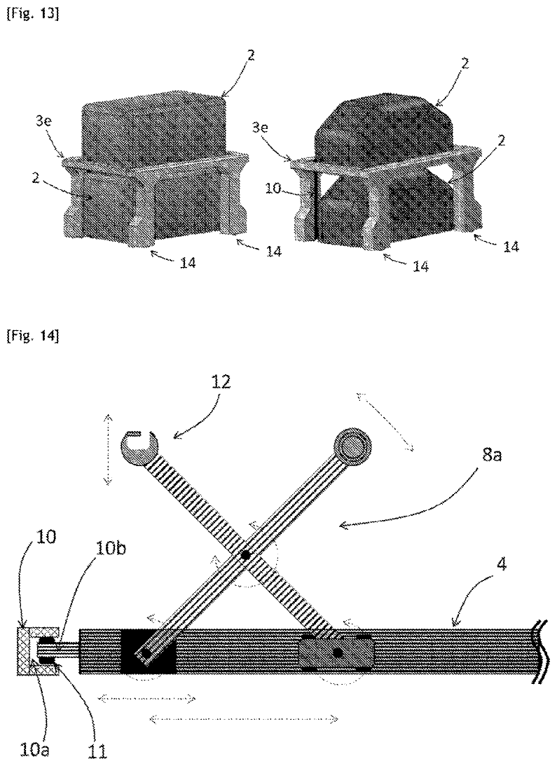

FIG. 13 shows 3D perspectives with transporters with modules transported on two levels according to a fifth embodiment. The module gripping means (not visible in the images) enabling this double lifting are integrated directly into guides positioned in the columns (i.e. no need for movable lateral uprights).

FIG. 14 schematically shows an upper view (above) of an embodiment of the module gripping means, of the scissor type, integrated into a movable upright connected to a vertical guide by a system of rolling bearings (or rollers). The mechanism of contact with the module is also shown.

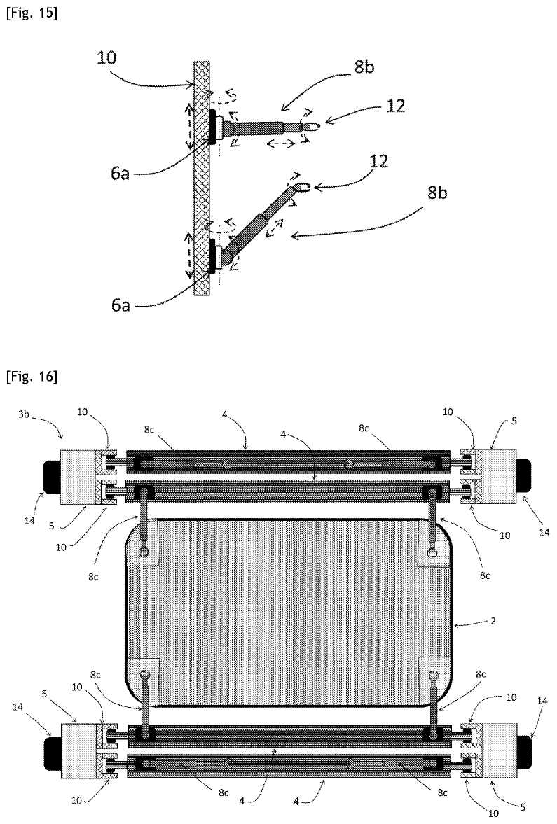

FIG. 15 schematically shows a lateral view (from the side) of an embodiment of the module gripping means, of the telescopic, pivoting and retractable arm type, integrated into a vertical guide by a lifting system not shown. The mechanism of contact with the module is also shown. Two mobile module gripping means are in the same vertical guide.

FIG. 16 schematically shows an upper (top) sectional view (not all parts are shown, such as for example the fixed uprights) of the second embodiment of the transporter device in which each column is associated with two vertical guides, allowing the lifting of a total of four movable uprights allowing the simultaneous carrying of two double-level modules. The means of taking are movable along the movable, retractable, variable-sized (telescopic) upright.

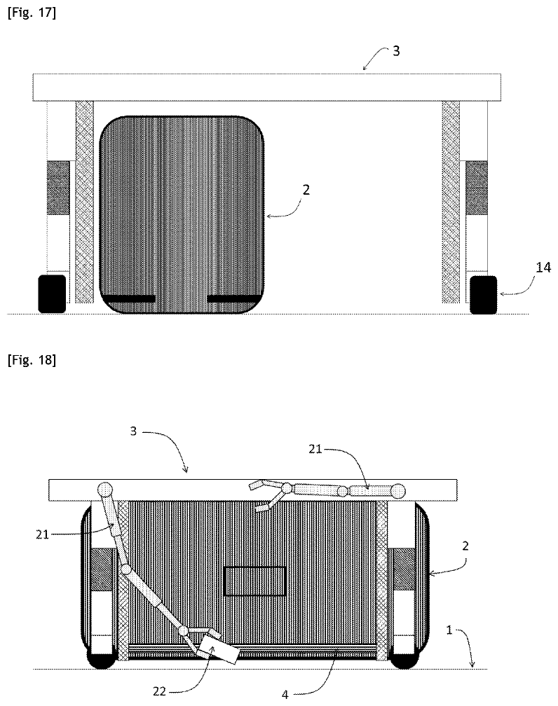

FIG. 17 schematically shows a lateral view (from the side) of a transporter device laterally straddling a module placed on the ground. The wheels of the traction system are oriented to allow this lateral movement.

FIG. 18 schematically shows a side view of a transporter device according to the invention, the device carrying a module and being provided with a manipulation arm configured to allow handling and loading of various objects.

The invention relates to transporting modules 2, in particular modules for the movement of people and goods. The modules 2 are without their own traction means, as distinct from the notion of vehicles. The modules 2 are, for example, containers, pallets, or modular shuttles for transporting people. The invention relates to a transporter device 3, 3a, 3b, 3c for the movement and parking of modules. The transporter device is a straddling device, configured to straddle interchangeable modules placed on the ground. The transporter device 3 is movable on traffic lanes 1 typically reserved for vehicles such as cars. This is in particular a device of the robotic type equipped with sensors and/or other devices to sense of the environment, allowing it to move and to detect its environment and more particularly objects, their relative positions, and the edges of the modules 2 to be moved. Optical sensors and/or a radar system can be envisaged.

In particular, the transporter device 3 comprises at least one computer and distance sensors, in particular at least one passive optical sensor (camera(s)), at least one sensor of the active optical type (LIDAR), a sensor of the radar type and/or of acoustic type. Advantageously, this aspect makes it possible to perform more rapid and secure operations, also allowing automated applications.

More particularly, the transporter device 3 comprises at least one computer and a radio frequency positioning device in particular of the GNSS type (or a positioning device RF) enabling the measurement of positions and heading. Advantageously, this allows for use in a context of low visibility for the operator and/or perception by the sensors. This may be practical in an outdoor environment.

According to one variant, in addition to the computer, the transporter device also comprises encoders allowing navigation by odometry. Advantageously, this allows for use in a low visibility context and to improve the accuracy of knowledge of positions and heading.

A variant can also be envisaged with a control unit inside the module or as part of the device. It allows for the partial or complete operation of the system by human operators moving with the device.

According to one variant, aside from the computer, the transporter device also comprises a wireless communication device (in particular using RF) allowing the command and the bidirectional exchange of data remotely. Advantageously, this allows manual or automatic control or monitoring remotely, the reception of the positioning corrections by RF (in particular differential GNSS or RTK).

Furthermore, the transporter device may comprise at least one communication device making it possible in particular to send data and commands wirelessly.

The transporter device 3 can be entirely autonomous and controlled by a robot. Alternatively or in combination, the transporter device may be semi-autonomous, that is to say allow partial control by a human operator. Alternatively or in combination, entirely manual control can be envisaged although this variant is not preferred.

With regard to now the structure of the transporter device 3, it preferably has central symmetry, which facilitates manufacturing by making the same part a plurality of times. In particular, the lateral sides consist of two generally identical frames.

The transporter device 3 comprises columns 5. In particular, these are pillars supporting the general structure of the transporter device 3. More particularly, there are four columns 5 distributed according to prism heights, preferably of parallelepiped shape. The columns 5 are configured to extend around the four corners of the module 2, or the set of modules, to be moved. The columns 5 are preferably generally identical.

In particular, the longitudinal and transverse distances between the columns 5 can be greater than those of the module 2 to be transported. This makes it possible to straddle the module 2 or other devices 3 in a reduced size configuration in the front/rear direction.

The transporter device 3 comprises at least one upright 6 attached to the columns 5. It is in particular two longitudinal uprights 6 in lateral position. In the preferred variant, the transporter device 3 further comprises at least one transverse upright 7, for example two transverse uprights 7. The transverse upright 7 makes it possible to transfer torque and potentially perform actuations. In preferred embodiments, the longitudinal uprights 6 and the transverse uprights 7 form a rectangular frame when seen from above. Preferably, the transporter device 3 further comprises at least one vertical guide 10, preferably fixed to a column 5. The upright 6 and/or the column 5 and/or the guide 10 is equipped with at least one module gripping means 8. This is in particular a structure configured to grip the module 2 to carry it and to move it. More particularly, the gripping means 8 is configured to grip the module 2 either by the chassis of the module 2a or by a carrying platform (not shown) on which the module 2 is arranged, or by auxiliary wheels in the module.

Thus, the gripping means 8 is configured to at least partially support the weight of the module 2 to be carried. In particular, the transporter device 3 comprises a plurality of gripping means 8 which together are configured to support the entire weight of a module 2 or a plurality of modules 2 to be carried. For example, the structure comprises pivotable and/or telescopic gripping arms 8a, 8b, 8c. The gripping arms may for example be scissor arms 8a, telescopic and retractable arms 8b integrated directly into the vertical guide 10, and/or telescopic and retractable arms 8c integrated directly into a movable longitudinal upright 4. As shown in FIG. 14, a scissor-type arm 8a can also be integrated, for example, into a movable upright 4 connected to a vertical guide 10 by a system of rolling bearings 11 (or rollers). This FIG. 14 also shows a mechanism 12 for contact with the module 2, between the gripping means 8a and the module 2. Such a mechanism 12 makes it possible to secure the gripping of the module 2 by the device 3.

In addition to the gripping means 8, the corresponding upright 6 and/or column 5 is also configured to at least partially support the weight of the module 2. In particular, the two longitudinal uprights 6 are configured to support all the weight of the module 2 or modules 2 to be carried.

The gripping means 8 is configured to be movable between a gripping position, that is to say deployed, and a release position, that is to say retracted. In the gripping position, the gripping means 8 extends at least partially below or inside the module 2. For example, the gripping arms 8a are pivoted to be arranged below the module. In particular, once in the gripping position, if the gripping means 8 is raised, it makes it possible to carry the module 2. The gripping position can be shown by FIG. 16. In the release position, the gripping means 8 does not extend below or inside the module 2. For example, the gripping arms 8a are pivoted to be arranged at a certain distance from the module 2. In particular, once in the released position, if the gripping means 8 is raised, it rises next to the module 2 without making it possible to carry the module 2. The release position can be shown by FIG. 15.

Preferably, each gripping means 8 is independent of the others in their changes in position and/or configuration. In a detailed variant below, each gripping arm 8a can position and/or change its configuration (e.g. deployed, folded, distance from the ground) independently of the other arms. Advantageously, this allows a more flexible gripping of the modules 2 relative to simultaneous actuation of a plurality of arms. In addition, this allows a gripping of modules 2 of different sizes. In addition, independent gripping means 8 allow simultaneous gripping and transport of a plurality of modules by the same device 3. In addition, this allows the placement of a module 2 next to another module 2, as well as the placement of a module above another module 2 forming a multi-level configuration to increase the transport capacity of the device 3.

FIGS. 10 and 11 show steps of the transporter device 3 approaching, gripping and transporting a plurality of modules 2, doing so over a plurality of levels.

The transporter device 3, configured with all of its module gripping means 8 in the retracted position, first moves toward a small module 2 placed on the ground (this first movement is not shown in the figures). The device 3 straddles the module 2, and stops in a suitable position for gripping the module 2.

A set of four module gripping means 8, associated with two inner movable uprights 4 of the device 3, articulated to grip the module 2. Then, lifting systems (not shown), associated with the inner movable uprights 4, lift the module 2 from the ground. The transporter device 3 can then continue its movement to a second module 2 (this second movement is not shown in the figures).

In order to grip the second module 2, the device 3 stops in a suitable position for the new gripping action. Then, the previously raised movable upright 4 is lowered to allow another set of four module gripping means 8 to take the second module 2.

As shown in FIG. 10, once the engaged movable uprights 4 lift the modules 2 off the ground, the device 3 can continue its movement. In order to be able to grip a third module 2 (shown in FIG. 11), the lifting systems must sufficiently increase the carrying height of the two modules 2 already present on the device 3 in order to allow the device 3 to straddle the third module 2.

The gripping of the third module 2 takes place with another set of four module gripping means 8, this time associated with two outer movable uprights 4. The gripping means 8 then change their position along the outer movable uprights 4 in order to adapt to the dimensions of this third module 2. The lifting systems of these outer uprights 4 lift the third module 2 off the ground to allow the transport of the set of three modules 2 in a two-level configuration.

According to one variant, the gripping means 8 are telescopic. Advantageously, this makes it possible to vary the width of the device 3 even if it is carrying a module 2 or a plurality of modules 2.

FIG. 15 shows an example embodiment of the gripping means 8 and its means of movement in the column 5. The arms 8a can be placed at different heights of the column 5. Column 5 comprises a guide and linear positioning system 6a for positioning the gripping means 8.

According to the invention, the gripping means 8 is movable between a lower position wherein the gripping means 8 makes it possible to position the corresponding arms in contact with the module 2, and an upper position wherein the gripping means is arranged above the height of the module 2 making it possible to grip other modules in the lower level or to straddle other elements such as a second device 3 with a slightly lower width and height or a module 2 placed in the lane 2.

Advantageously, the transporter device 3 according to the invention makes it possible to have space at the bottom when the gripping means 8 carrying a module 2 is in the upper position. It is therefore possible to straddle modules 2 longitudinally and/or laterally, unlike the solutions of the prior art. In addition, the transporter device 3 is easy to maneuver since it makes it possible to straddle modules 2 or other devices in order to move along the lane 1. Furthermore, the transporter device 3 does not require significant modifications to be able to straddle another transporter device 3 or significant modifications of the lane 1 to perform simultaneous movements in both directions.

Focusing now on the lifting system of the transporter device 3 that makes it possible to lift the carried module(s), it may comprise pinions and racks associated with a lifting actuator. It may comprise one or more lifting jacks with telescopic arms. Lifting chains or cables or vertical ball screws are also possible variants.

In one variant, the lifting system comprises pivoting structures, for example levers made of scissor structures (not visible in the figures), attached to the longitudinal uprights in another embodiment.

According to the preferred variant, at least one column 5 comprises at least one movement guide 10 for the movements of the gripping means 8. This is for example at least one female structure cooperating with at least one male structure, preferably with rolling bearings 11 (or rollers).

In particular, as shown in FIG. 14, the column 5 comprises a concave primary female structure 10a, for example in a “C” or “U” shape; and the movable upright 4, or the gripping means 8 comprises the primary male structure 10b housed in the primary female structure 10a.

Advantageously, these guides 10 make it possible to stress the vertical movement of the first means 8 and thus the actual transfer of mechanical loads directly between the upright 6 and the columns 5. This is particularly advantageous for transferring loads of the longitudinal force type, lateral forces and torque along the longitudinal axis. The guides 10 positioned near the columns 5 make it possible to free the space between columns 5 and to give the capacity to straddle between them.

In one variant such as that shown in FIG. 11, intermediate columns or guides 10 can be used with associated lifting actuators.

Preferably, the lifting system comprises a locking mechanism enabling the positioning of the gripping means 8 and/or of the movable longitudinal uprights 6 at different heights and thus allowing the transportation of the modules 2 at different distances from the ground.

Regarding traction, according to one variant, the transporter device 3 comprises a traction system 13 associated with main wheels 14, preferably multidirectional wheels. It is in particular at least four wheels 14 arranged at or near the columns 5.

Preferably, at least one steering motor is provided by a non-tensile participating column 5.

In one variant, at least two wheels are motorized for traction and at least two wheels have a steering motor.

Furthermore, the proposed traction systems also make it possible to perform rapid rotations and changes in direction of movement, to minimize the radius of curvature (or deflection) and to laterally straddle. In order to straddle a module 2 or object laterally, the transporter device 3 lifts at least the movable uprights 4 and configures the traction system for a generally lateral movement. The wheels 14 are then generally at 90 degrees, as shown in FIG. 17.

The traction system can also be arranged next to the column 5, and not only above the latter. It may also be arranged along the lower uprights 6 for certain mechanical configurations.

According to one embodiment, the longitudinal upright 6 is adjustable in size. Thus, the longitudinal distance between the main columns can be varied by the longitudinal uprights 6 provided for example with a telescopic device 16, visible in FIGS. 2 and 3. The longitudinal uprights 6 can be fixed 19 and/or mobile 4, that is to say that the adjustment is fixed or modular during operation. This is also true of the fixed longitudinal uprights 19 if necessary. Advantageously, this makes it possible to optimize the size of the device 3 to modules 2 of different sizes, and to optimize the size of the transporter device 3 for its transport (e.g. in a shipping container, or in an air transport cargo hold).

According to one embodiment, the transverse upright 7 is adjustable in size.

Thus, the lateral distance between the columns is variable by transverse uprights 7, provided for example with a linear telescopic device. The transverse uprights 7 can be fixed and/or mobile, that is to say that the adjustment is fixed or modular during operation.

Advantageously, this makes it possible to optimize the width of the device 3 to straddle or to be straddled, in particular by another device 3. This aspect can be shown by FIG. 12. This also makes it possible to optimize the size of the transporter device 3 for its transport and for lanes 1 of reduced width. This aspect can be shown by FIG. 6, for the linear telescopic device 16.

According to one embodiment, the column 5 is adjustable in size. In particular, the height of the columns 5 is variable by telescopic devices 16. Advantageously, this makes it possible to optimize the size of the transporter device 3 to straddle or to be straddled, in particular by another device 3. This aspect can be shown by FIG. 5. This also makes it possible to optimize the size of the transporter device for its transport, to optimize the size to access spaces with reduced height, to keep the module 2 level on sloping ground while moving, and to integrate suspension systems for the columns 5 associated with the traction system 14.

According to one embodiment, the transporter device further comprises at least one fixed upright carrying one or more of said lifting means.

According to one variant, the transporter device further comprises at least one articulated and/or robotic handling arm 21 on its frame. The handling arm 21, visible for example in FIG. 18, is preferably arranged on a transverse upright 7, more preferably on the side thereof. It is also possible to envisage placing said arm 21 on at least one column 5 and/or at least one upright 6, 19. It may have a fixed or variable position.

As shown in FIG. 18, the handling arm 21 is configured to allow handling and carrying of various objects 22 such as parcels inside a module, cameras or other type of inspection device, extinguishers and sensor cleaners. It may be called inspection arm 21 when the arm comprises a camera or other type of inspection device. Thus, the invention further relates to a transporter device comprising said handling/inspection arm 21.

Advantageously, the handling arm 21 allows the manipulation, movement and placement of objects, such as parcels, between a module and a storage site or the ground.

Furthermore, the handling arm 21 can allow the removal of the objects or obstacles in the path of the transporter device such as branches, residue, and snow.

In addition, the handling arm 21 can allow the effective action of a fire extinguishing device without the intervention of a human in case of fire on a device or module.

The handling arm 21 can allow intervention on the devices and modules, that is to say unlocking a mechanism, pulling another device, exchanging electric batteries, and cleaning sensors.

The invention further relates to a passing system, between two transporter devices 3 as described above or between a device and a module, on the same traffic lane, this system enabling coordination as well as a control of the geometric configurations of said devices and the positioning of modules on each of the devices. For example, a centralized control, preferably robotic and with a means of communication between the devices, determining the geometric configuration of each transporter device 3, more particularly the heights of columns 5, the widths of the transverse uprights 7 and the positioning of the gripping means 8, to cause the devices to pass one another at different speeds on the same sector of a single lane. The relative movement can be carried out with one of the devices stopped, or with one module 2 stopped (the module placed on the lane), or with the two devices in motion, the motion being positive (same direction of movement for both devices) or negative (opposite directions of movement).

This passing system makes it possible to implement an optimized sharing of the traffic lane, in particular with the possibility of moving more people, goods and/or transporter devices 3 in both directions of movement, even if a device or module is stopped on the same lane. In addition to this increased bi-directional flow capacity, the traffic lane can also serve as a parking space for modules 2, transporter devices or other types of goods.

Another object of the invention relates to a passing method, comprising steps of adjusting the height of the device 3, adjusting the width of the device 3, adjusting the height of the possible modules carried by the device(s) involved in passing, and straddling by means of at least one transporter device 3 as described above, or a system for moving and parking as described above.

This is in particular a control method comprising steps of geometric preparation (height, width, configuration of the gripping means) by the actuators described previously for a variation in size of the columns 5 and of the uprights and for the positioning of the gripping means 8, and a step of longitudinal and/or lateral straddling comprising coordinated control steps of the transporter devices 3.

Provided that the transverse distances between the main columns 5, between the heights of the transverse uprights 7, and between the heights of any carried modules are sufficient and/or that the means for gripping in configuration allow for straddling, for example in the released position, the transporter device 3 can easily straddle another moving or stopped device 3 in the forward/backward direction or stop or straddle a module placed on the lane. This can be shown in FIGS. 5 to 7. Advantageously, this makes it possible to be able to move and place modules and transporter devices without requiring multiple lanes.

According to the invention, the method comprises steps of geometrically adapting the transporter device(s) 3 to allow passing, of aligning the straddling device and/or the straddled device, and of passing by straddling, with at least one of the two devices being in motion. The straddling device may or not be carrying (or loaded with) modules at the time of passing the second device. Also, the second device may or not be carrying (or loaded with) modules at the time of being straddled by the first device. This method has a notable advantage for the recovery of lanes traveled by vehicles, for example cars, in favor of urban spaces.

The invention further relates to a computer program comprising program code instructions for the execution of the steps of a method as described above, when said program operates on a computer.

The invention further relates to a computer program comprising program code instructions for the execution of the steps of implementing a transporter device as described above, in particular steps of controlling the elements of a transporter device as described above, when said program operates on a computer. Each movement or action of a transporter device or part thereof can be considered a computer-implemented step of the method.

Another object of the invention relates to a controlled system for moving and parking modules, such as an autonomous or semi-autonomous robotic system.

The controlled system comprises a control unit in which a program as described above is loaded, as well as at least one transporter device as described above.

The control unit can be remote from the transporter device, for example in an urban traffic control area.

1. A transporter device (3, 3a, 3b, 3c) for moving and parking modules (2), each module (2) being devoid of its own traction means, the transporter device being movable and comprising at least one module gripping means (8) configured to be movable between a gripping position wherein said gripping means (8) extends at least partially under or inside the module, preferably in the bottom sector or the underneath of the module, and a release position wherein said gripping means does not extend into the module, said gripping means (8) being configured to support the weight of the module (2), the device comprising at least one computer associated with sensors, for controlling the movement of the transporter device (3, 3a, 3b, 3c) and the gripping means (8), the device comprising at least one column (5), and at least one upright (6) connected to said column (5), the transporter device (3, 3a, 3b, 3c) being configured to be able to straddle modules, characterized in that the transporter device comprises at least one vertical guide (10) to guide the movements of at least one gripping means (8).

2. The transporter device according to the preceding claim, characterized in that said upright is a longitudinal upright (6, 4) movably mounted between a lower position wherein said longitudinal upright (6, 4) makes it possible to position said gripping means (8) at least partially below or inside the module when the latter is placed on the ground, and a higher position in which said longitudinal upright (6, 4) is arranged above the height of the module (2).

3. The transporter device according to one of the preceding claims, characterized in that the vertical guide (10) is equipped with at least one gripping means (8).

4. The transporter device according to one of the preceding claims, characterized in that said module gripping means (8) is retractable and/or of variable size.

5. The transporter device according to one of the preceding claims, characterized in that the columns (5) and/or uprights (6, 4, 19, 7) are adjustable in size.

6. The transporter device according to one of the preceding claims, characterized in that the transporter device is configured to be able to straddle modules or other transporter devices laterally and/or longitudinally.

7. The transporter device according to one of the preceding claims, characterized in that it is configured to transport more than one module.

8. The transporter device according to one of the preceding claims, characterized in that it is configured to take and transport simultaneously at least two modules in a multi-level configuration.

9. The transporter device according to one of the preceding claims, characterized in that it comprises a traction system associated with multidirectional wheels (14), controlled by said computer.

10. The transporter device according to one of the preceding claims, comprising at least one lifting system, characterized in that the lifting system comprises lifting subsystems attached and/or integrated with at least one upright (6, 4, 19) and/or at least one column (5).

11. The transporter device according to one of the preceding claims, comprising a plurality of vertical guides (10) and a plurality of columns (5), each column (5) being provided with a plurality of vertical guides (10).

12. The transporter device according to one of the preceding claims, comprising a plurality of columns (5), the or each vertical guide (10) being arranged between the columns (5).

13. The transporter device according to one of the preceding claims, characterized in that the transporter device (3, 3a, 3b, 3c) comprises at least one preferably robotic manipulation/inspection arm.

14. A system for moving and parking modules (2), comprising at least two transporter devices (3, 3a, 3b, 3c) according to one of the preceding claims.

15. A method for moving transporter devices (3, 3a, 3b, 3c), carried out by means of a movement and parking system according to claim 14, characterized in that it comprises a step of positioning and aligning the transporter devices on a single lane, a step of geometric adaptation of the size of a first transporter device; and a step of straddling a second transporter device carried out by said first transporter device.

16. The method according to the preceding claim, further comprising a step of gripping a module carried out by one of the transporter devices, and a step of moving the module carried out by at least one of the transporter devices.

17. The method according to the preceding claim, characterized in that it comprises a step, carried out by the transporter device which has gripped the module, of vertically positioning the module on the transporter device.

18. A computer program comprising program code instructions for the execution of the steps of a method according to one of claims 15 to 17, when said program is run on a computer.
